(19) United States
(12) Patent Application Publication
(10) Pub. No.: US 2004/0265459 A1
(43) Pub. Date: Dec. 30, 2004

(54) Potentiation of microbial lethality of gaseous biocidal substances

(76) Inventors: David James Lark, Woodburn (AU); Andrew Inglis, Wybong (AU); Crispin Marsh, Birchgrovc (AU)

Correspondence Address: ROTHWELL, FIGG, ERNST & MANBECK, P.C., 1425 K STREET, N.W., SUITE 800, WASHINGTON, DC, 20005, US

(21) Appl. No.: 10/486,689

(22) PCT Filed: Aug. 15, 2002
(86) PCT No.: PCT/AU02/01103

(30) Foreign Application Priority Data
Aug. 15, 2001 (AU) PR7015
Aug. 16, 2001 (AU) PR7088

(51) Int. Cl. A23L 3/34

(52) U.S. Cl. 426/532

(57) ABSTRACT

A process for reducing viable microbial content of a substantially solid material which is susceptible to microbial spoilage or contamination, the process comprising: (a) entraining a biocidal substance in a carrier gas to form a biocidal gas mixture by adding a biocidal substance to a heated carrier gas; and (b) contacting exposed surfaces of the solid material with the biocidal gas mixture heated to an elevated temperature of at least about 10° C. above the dew point of the biocidal gas mixture for a sufficient period of time so that at least some microbes on the exposed surfaces are exposed to the biocidal substance in the biocidal gas mixture.

### FIELD OF THE INVENTION

The invention relates to a process and apparatus for the generation of a biocidal gas containing one or more biocidal substances entrained in a heated carrier gas. The invention also related to use of the biocidal gas containing one or more biocidal substances for treating solid materials to reduce viable microbial content of solid material, particularly foodstuffs.

### BACKGROUND TO THE INVENTION

Hitherto, conventional gaseous processes aimed at extending the shelf-life of materials prone to microbial spoilage have relied on modified atmosphere (MAP) procedures. In such procedures, the oxygen gas atmosphere surrounding the material is replaced with a food grade carbon dioxide and/or nitrogen atmosphere, and high barrier co-laminate packaging is used to maintain the exclusion of oxygen from the package. However, MAP processes have disadvantages. That is, whilst it has been found that an extension of the shelf-life can be achieved in respect of materials treated by the procedures, the extension is often limited. Furthermore, considerable costs are involved including the cost associated with the requirement for specialised co-laminate film packaging.

In Australian Patent No 730402 (the entire disclosure of which is to be regarded as incorporated herein by reference), the present applicant described an alternative method for extending the shelf-life of materials prone to microbial spoilage involving treating a material with a volatile biocidal substance(s) such as a natural food acid (eg. acetic acid) entrained in a carrier gas within an evacuated treatment vessel. Subsequently, the present applicant found that it was not necessary to evacuate the treatment vessel in order to achieve a satisfactory extension of shelf-life. This ‘no-vacuum’ method is described in its Australian Patent No 734421 (the entire disclosure of which is to be regarded as incorporated herein by reference).

The process and apparatus described in the above mentioned patent specifications for the generation of the biocidal gas comprised the bubbling of the carrier gas through the liquid volatile biocidal substance or a solution thereof. In the case where the biocidal substance is carbonic acid and the carrier gas carbon dioxide, the carbonic acid was formed in situ by bubbling the carrier gas through water.

The present invention represents an unexpected enhancement of the method described in the present applicant's previous patents for inventions relating to prevention of food spoilage. This modified process for the formation of the biocidal gas mixture allows the apparatus required to carry out the process to be greatly simplified, thereby reducing the cost of the process.

### SUMMARY OF THE INVENTION

The present invention relates generally to generating a biocidal gas mixture by adding a volatile biocidal substance(s) to a carrier gas and using the biocidal gas mixture to treat a solid material.

Thus, in a first aspect, the present invention provides a process for reducing viable microbial content of a solid material for consumption which is susceptible to microbial spoilage and which has an exposed surface having a water activity of greater than or equal to about 0.85, the method comprising contacting exposed surfaces of the solid material with a gas mixture comprising a major portion of a carrier gas and a minor portion of a volatile biocide, wherein the carrier gas and/or the gas mixture is heated such that it has a temperature between 30° C. and 300° C. above the dew point of the gas mixture before contacting the exposed surfaces of the solid material.

Preferably, the carrier gas is heated to a temperature in the range of about 60° C. to 200° C., and more preferably, about 80° C. to 200° C.

Preferably, the carrier gas is selected from the group consisting of carbon dioxide, nitrogen, and mixtures thereof.

Preferably, the biocidal substance is selected from the group consisting of natural food acid, volatile chemical biocide, and mixtures thereof. The natural food acid is preferably acetic acid, carbonic acid, or mixtures thereof. More preferably, the natural food acid is acetic acid.

Preferably, the volatile chemical biocide is hydrogen peroxide. In a preferred form, the biocidal substance is entrained in the carrier gas.

In a second aspect, the present invention provides an apparatus for generating a biocidal gas mixture for use in reducing viable microbial content of a substantially solid material having a water activity of greater than or equal to about 0.85, the apparatus comprising:

(a) a duct to carry a stream of a carrier gas;

(b) a heater to heat the carrier gas to an elevated temperature; and

(c) addition means to add a biocidal substance to the carrier gas in an amount up to that required to saturate the carrier gas to form a biocidal gas mixture at elevated temperature of at least about between 30° C. and 300° C. above the dew point of the biocidal gas mixture.

The biocidal substance may be sprayed into the carrier gas stream; it may be poured or dripped into the duct carrying the carrier gas stream and allowed to evaporate therein; or it may be nebulised in an ultrasonic nebuliser and then entrained into the carrier gas stream and allowed to vaporise. As it is desirable that the biocidal gas mixture does not contain particles of biocidal substance, the biocidal substance should be added to the carrier gas in an amount which is preferably less than that required to saturate the carrier gas.

In a third aspect, the present invention provides a process for reducing viable microbial content of a substantially solid material having a water activity of greater than or equal to about 0.85 and which is susceptible to microbial spoilage or contamination, the process comprising:

(a) entraining a biocidal substance in a carrier gas to form a biocidal gas mixture by adding a biocidal substance to a heated carrier gas; and

(b) contacting exposed surfaces of the solid material with the biocidal gas mixture heated to an elevated temperature of at least about 30° C. and 300° C. above the dew point of the biocidal gas mixture for a sufficient period of time so that at least some microbes on the exposed surfaces are exposed to the biocidal substance in the biocidal gas mixture.

The solid material can be any food type that is susceptible to microbial spoilage or contamination. The material can be food products, food ingredients, baked goods, bread, whole grain cereals, whole or diced berries, fruits, vegetables, salads, nuts in their shell, stored nut meats, cheese, smallgoods, cured meats, meat, chicken flesh, carcass on abattoir chains, seafood, fresh water foodstuffs, herbs, spices, and mixtures thereof. The present invention is particularly suitable for small goods or cured meats.

Preferably, the carrier gas is heated to a temperature in the range of about about 60° C. to 200° C., usually about 80° C. to 200° C. above the dew point of the biocidal gas mixture.

Preferably, the carrier gas is selected from carbon dioxide, nitrogen, or mixtures thereof.

Preferably, the biocidal substance is a natural food acid, a volatile chemical biocide, or mixtures thereof.

Preferably, the natural food acid is selected from the group consisting of acetic acid, carbonic acid, and mixtures thereof. More preferably, the natural food acid is acetic acid.

Preferably, the volatile chemical biocide is acetic acid, hydrogen peroxide, or mixtures thereof. In one preferred form, the biocidal substance is entrained in the carrier gas.

The elevated temperature of the biocidal gas mixture is usually in the range of about 80° C. to 300° C. Preferably, the elevated temperature of the biocidal gas mixture is at least 50° C. above the dew point temperature of the biocidal gas mixture. More preferably, the elevated temperature of the biocidal gas mixture is greater than about 100° C. above the dew point temperature of the biocidal gas mixture. Even more preferably, the elevated temperature of the biocidal gas mixture is at least about 150° C. above the dew point temperature of the biocidal gas mixture.

The surfaces of the solid material are usually contacted with the biocidal gas mixture for a short time. Preferably, the surfaces of the solid material are contacted with the biocidal gas mixture for about 2 minutes or less. In a more preferred form, the surfaces of the solid material are contacted with the biocidal gas mixture for about 10 seconds to 1 minute.

In a fourth aspect, the present invention provides an apparatus for reducing viable microbial content of a substantially solid material having a water activity of greater than or equal to about 0.85 which is susceptible to microbial spoilage or contamination, the apparatus comprising:

(a) means to form a biocidal gas mixture from a biocidal substance and a carrier gas;

(b) vessel adapted for holding a substantially solid material which is susceptible to microbial spoilage or contamination;

(c) means for introducing the biocidal gas mixture into the vessel; and

(d) means for heating the carrier gas or the biocidal gas mixture or both the carrier gas and the biocidal gas mixture to form a biocidal gas mixture at an elevated temperature of at least about 30° C. and 300° C. above the dew point of the biocidal gas mixture.

In use, the solid material is placed in the vessel, the biocidal substance is mixed with the carrier gas at an elevated temperature to form the biocidal gas mixture which mixture is heated or maintained to at least about 30° C. and 300° C. above the dew point (saturation temperature) of the biocidal gas mixture. The heated biocidal gas mixture is then passed to the solid material in the vessel so as to expose at least some microbes on the solid material to the biocidal substance in the gas mixture.

In a fifth aspect, the present invention provides use of the process according to the third aspect of the present invention for reducing viable microbial content of a substantially solid material which is susceptible to microbial spoilage or contamination.

In a sixth aspect, the present invention provides use of the apparatus according to the fourth aspect of the present invention for reducing viable microbial content of a substantially solid material which is susceptible to microbial spoilage or contamination.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this application.

In order that the present invention may be more clearly understood, preferred forms will be described with reference to the following drawings and examples.

### BRIEF DESCRIPTION OF THE DRAWINGS

FIGURE 1 is a schematic of an apparatus for forming a biocidal gas mixture according to the present invention.

### MODE(S) FOR CARRYING OUT THE INVENTION

The process and apparatus according to this invention to generate a biocidal gas mixture provide for the carrier gas to be heated prior to the addition of the biocidal substance to form the biocidal gas mixture. The gas is preferably heated to a temperature of from about 30° C. to 300° C., more preferably from about 60° C. to 200° C. Preferably, the gas is heated to a temperature such that after the biocidal substance has been added to the carrier gas, the biocidal gas mixture has a temperature which is at least about 30° C. higher than the dew point of that biocidal gas mixture.

The carrier gas may be heated in a gas-fired heater or an electrically powered heater or heated in any other suitable manner. As the gas is not combustible, it would be possible to pass the gas directly over an electrical heating coil for instance. Alternatively, the gas can be heated in any other conventional way such as passage through a duct submersed in a heated oil bath.

In preferred embodiments of the invention, the carrier gas temperature is such that after the biocidal substance has been entrained, the temperature is equal to or higher than that at which the biocidal gas mixture is to be applied to the substrate to be treated. It is, however, within the scope of the invention to further heat the biocidal gas mixture after it has been formed.

The biocidal substance to be placed in the carrier gas stream may be sprayed into the heated gas stream where it can evaporate in situ; it may be dribbled into the stream and be allowed to evaporate from a surface over which the gas flows; or it may be nebulised and the mist so formed be entrained into the heated gas stream. The biocidal substance may be introduced into the carrier gas stream in an amount that is in excess of that required to saturate the carrier gas. In which case, the excess biocidal substance will remain unevaporated in the apparatus unless provision is made for the excess to be drained or removed. It is, however, preferred that the biocidal substance is introduced in an amount less that is required to saturate the carrier gas stream.

In the earlier related inventions, the present inventors had previously deliberately restricted the temperature at which the gas mixture was applied to a substance to be treated to a temperature just above that needed to maintain the volatile biocidal substance(s) in the gaseous state. It was thought that if the temperature dropped below the dew point i.e. the temperature at which the gas became saturated with the biocidal substance(s) and it began to condense, then deleterious effects would occur and the efficacy of the process would drop. It was also thought that the temperature should be maintained only just above the dew point to save on energy usage and to avoid heat induced degradation of the solid material. As the solid material will normally be foodstuffs, it was assumed that the application of very hot gases to a foodstuff would induce cooking of the foodstuff. This would be deleterious to the appearance or flavour of the foodstuff and/or cause excessive temperature rises, typically within meat processing areas normally controlled down to 4° C. It had also been previously believed that if the temperature was increased excessively, the gaseous biocidal substance(s) would become increasingly more soluble in the carrier gas resulting in a decrease in the rate of partitioning to the water on the surface of the material being treated. This was thought to result in a decrease in process efficacy and/or an increase in treatment times. Further development by the present inventors has now shown that the need to strictly control the temperature of the gaseous biocidal substance(s) is not required. The present inventors have now found that if the biocidal gas mixture is heated substantially above the dew point, the efficacy of the process is increased significantly and surprisingly there appear to be no deleterious effects from the application of the hot gas to the solid target material.

The process according to the present invention is preferably carried out by heating the carrier gas to a temperature very substantially above the dew point such that after the biocidal substance(s) has been entrained in the gas, the biocidal gas mixture still has a temperature at least about 10° C. above the dew point.

The biocidal substance(s) may be entrained in the carrier gas at a first temperature just above the dew point by ensuring the injected volatile biocidal substance(s) is not in saturating amounts and is at a desired percentage, that is less than 100%, of the saturation concentration at the dew point and then heated in a second step to a temperature at least 10° C. above the dew point prior to its application to the solid material. Alternatively, all the heating could be performed in one step at the time of initial heating of the gas.

Preferably, the entraining or first temperature is in the range of about 30° C. to 200° C., dependent on the type and concentration of the biocidal substance(s), the desired gaseous concentration, the method of entrainment and the relevant safety issues for the latter parameters.

Preferably, the carrier gas is carbon dioxide and/or nitrogen gas. Previously, carbon dioxide had been the preferred gas due to its higher carrying capacity for the biocidal substances of interest. It has been now found that if the biocidal substance is entrained in the gas at a temperature substantially above the saturation temperature it is quite feasible to get sufficient biocidal substance entrained in a nitrogen gas stream. Nitrogen has the advantages of being cheaper than carbon dioxide and does not have the same health and safety concerns. As mentioned above, the volatile biocidal substance(s) is selected from natural food acids, chemical biocidal substances and mixtures thereof. Preferably, the volatile biocidal substance(s) is selected from acetic acid, carbonic acid, hydrogen peroxide and mixtures thereof.

In use the temperature of the biocidal gas mixture is preferably, at the time it is applied to the substrate, at or greater than about 10° C. above the dew point temperature of the gas mixture. Preferably, the temperature is greater than about 50° C. above the dew point temperature, more preferably greater than about 100° C. above the dew point temperature, and most preferably at least about 150° C. above the dew point temperature. Generally, the temperature at which the biocidal gas is applied to the solid material will be within the range of 80° C. to 400° C. If the temperature of the biocidal gas mixture is, at some point, above that required to achieve the desired microbial lethality, the heating of lines downstream may be achieved by the heated gas mixture itself.

The practical limit of ‘post heating’ may be more related to accumulated heat effects on surrounding equipment etc. A cooling and/or condensation point may be required in some applications. The heating of the biocidal gas mixture well above its dew point achieves improved reductions in the microbial bioburden of solid materials and the additional heat imparted to the materials as a result of the heating of the biocidal gas mixture, as shown in the following non-limiting example, has been found to be minimal and insufficient to cause any substantial degradation or other adverse effects.

Solid materials suitable for treatment with the process of the present invention, preferably have exposed surfaces with a water activity (A_{w}) greater than or equal to 0.85, more preferably, greater than or equal to 0.95. Where the solid materials to be treated have exposed surfaces of less than 0.85, it is preferred to wet the surfaces (e.g by spraying with a fine mist of water or preferably free steam). It is believed that exposed surfaces with a water activity (A_{w}) of greater than or equal to 0.85 ensures that the gaseous biocidal substance(s) present in the biocidal gas mixture rapidly partitions into the moisture present at the surface of the solid material. This rapid partitioning of the gaseous biocidal substance(s) into the surface moisture of the solid material will cause that moisture, which is also in contact with any microbes on the surface of the solid material, to transiently have a very high concentration of the volatile biocidal substance(s). Though transient, the very high concentration of the volatile biocidal substance(s) in the surface moisture has a high lethality for microbes, particularly as at high concentrations the volatile biocidal substance(s) is likely to be in an undissociated state and therefore more likely to penetrate the cell walls of the microbes.

The transient nature of the high concentration of the volatile biocidal substance(s) on the surface of the solid material is due to a preferred short treatment time (i.e. 2 minutes or less), and due to the equilibration of the volatile biocidal substance(s) through the solid material after the treatment has been completed. The result of the equilibration following the treatment is that the solid material as a whole will end up containing a relatively smaller concentration of the volatile biocidal substance(s) despite having had a very high surface concentration transiently during the treatment step.

Preferably, the step of contacting the solid material with the biocidal gas mixture is performed with an over-pressure of 0.01-0.5 bar (7.5-375 mm Hg) over atmospheric pressure, in order to achieve optimal partitioning of the volatile biocidal substance(s) into the surface water of the solid material.

Preferably, the contacting period used in the present invention is about 1 minute or less and, more preferably, less than about 30 seconds. Most preferably, the contacting period is less than about 10 seconds. In preferred embodiments of the invention, the treatment period is between about 1 and 4 seconds.

For some solid materials (e.g. those having a particularly high microbial bioburden), it may be preferred to repeat the application of the biocidal gas mixture until the required reduction in viable microbial content of the solid material is achieved.

The process and apparatus of the present invention is preferably operated without a step of evacuating the treatment vessel as is described in Australian Patent No 730402.

The process and apparatus of the present invention should not require the use of a trap to prevent/remove droplets from contacting the solid material if the biocidal gas mixture is heated to beyond the vaporisation temperature of the volatile biocidal substance. It is preferred that the gas-contact surfaces of all conduits (and any accumulator(s) and/or appropriate sections of treatment equipment) be heated sufficiently to maintain the gas mixture at a temperature at least about 10° C. above the dew point or at a temperature sufficiently hot to maintain the biocidal gas stream at the desired temperature above the dew point.

If an accumulator is used in the present invention, suitable accumulators may consist of a flexible membrane/bag/bellows to allow for expansion and contraction proportional to the volume of biocidal gas mixture contained within the accumulator. This acts as an accumulator of aerosol/gas and thereby minimises variations in concentration of the volatile biocidal substance in the carrier gas which may otherwise occur as a result of variances in the mass of aerosol carriage and/or pressure fluctuation effects on the biocidal gas mixture within a rigid vessel of constant volume. When functioning as an accumulator and/or for mixing various types of gaseous biocidal substances, the flexible vessel may be placed after the heating step and prior to the contact step.

If the formed biocidal gas mixture is to be subjected to secondary heating, it is preferably heated using standard heater units (eg passage through a heat transfer device submerged in a bath containing an appropriate heat transfer medium and maintained at the desired temperature) in a manner such that the resulting heated biocidal gas mixture is homogenous at the time of the contacting step with the solid material being treated. That is, the ‘post heater’ will typically consist of a heated surface or surfaces whereupon the biocidal gas mixture comes into contact for a sufficient period of time to at least ensure that the resultant biocidal gas mixture is free from visible droplets of the volatile biocidal substance(s) that may detrimentally affect the material being treated or result in a decrease in process efficacy. More preferably, the resultant biocidal gas mixture is substantially free from all droplets of the volatile biocidal substance(s) and is heated to the desired second temperature.

The step of entraining the volatile biocidal substance(s) in the carrier gas may occur within the post heater unit. For example, the volatile biocidal substance(s) and the carrier gas may be separately or simultaneously injected directly into the post heater. Where the biocidal gas is actually a mixture of such substances, it may be necessary to inject each of the individual biocidal substances separately to ensure that a homogenous biocidal gas mixture is formed. This may be particularly important where the biocidal substances are somewhat incompatible (e.g. acetic acid and hydrogen peroxide).

Solid materials that can be treated by the process and apparatus of the present invention include food products and ingredients including baked goods such as bread, whole grain cereals, whole or diced berries, fruits or vegetables, prepared salads, nuts in their shell, stored nut meats, cheese, smallgoods, cured meats, chicken flesh, carcass on abattoir chains, sea and fresh water foodstuffs, and herbs and spices. The process and apparatus of the present invention is also suitable for the treatment of pharmaceutical compositions and individual pharmaceutical ingredients.

The present invention may also be used in combination with typical MAP or vacuum processes to increase the shelf-life of certain solid materials.

The process of the present invention may also comprise an additional step of packing the treated solid material within gas barrier packaging to form and/or maintain an atmosphere of said gaseous biocidal substance(s) substantially in equilibrium with the volatile biocidal substance(s) that has partitioned into the solid material.

The process of the present invention may be performed batch-wise or continuously, and preferably in a suitable vessel or around a suitable structure such as a conveyor belt. When a batch method is used, wrapped or bagged (but unsealed) solid material is preferably loaded and unloaded into a treatment vessel manually. When a continuous flow mode is desired, commercially available flow wrapping equipment utilising a conveyor and/or contacting of the biocidal gas mixture with the solid material in a tunnel can be used.

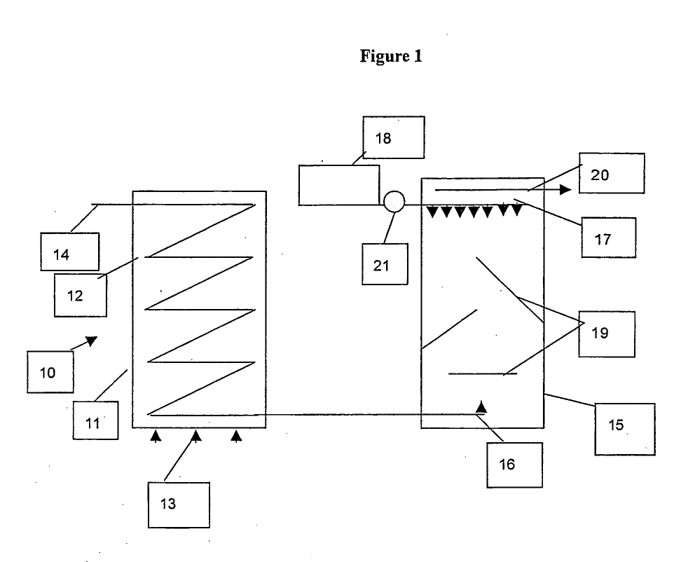

The preferred arrangement of an apparatus for forming a biocidal gas mixture according to this invention is shown diagrammatically in FIG. 1. The apparatus 10 includes a heater chamber 11 in which is disposed a helical gas duct 12. The chamber 11 is heated by a number of burners 13 at the base of the chamber 11. An inlet duct 14 carries a carrier gas such as nitrogen from a storage tank (not shown) to the helical gas duct 12. Heated carrier gas is conveyed into a biocidal substance addition chamber 15 through duct 16. The biocidal substance is preferably sprayed into the chamber 15 using high pressure metering pump 21 to cause the fine atomisation of the biocidal substance. This will assist in the vaporisation of the biocidal substance in the hot carrier gas.

The biocidal substance addition chamber 15 has a series of spray nozzles 17 in its upper end adapted to spray a biocidal substance such as 75% acetic acid from a storage tank 18 into the biocidal substance addition chamber 15. A number of baffles 19 are positioned in the biocidal substance addition chamber 15 to cause the nitrogen carrier gas introduced into it to assume a turbulent flow so that the acetic acid sprayed into the chamber 15 will be homogeneously mixed with the carrier gas. The biocidal gas mixture formed in the chamber 15 is conveyed through duct 20 to a substrate to be treated. If desired, the duct 20 may be lagged or heated to prevent undue cooling of the biocidal gas mixture prior to its application to the substrate.

In use the carrier gas is introduced to the heating chamber 11 through duct 14 and heated in the helical duct 12 to a temperature of from about 110° C. to 200° C. The heated carrier gas is introduced into the biocidal substance addition chamber 15 through the duct 16. Simultaneously, the metering pump 21 meters the required amount of biocidal substance under pressure into the chamber 15. The biocidal substance vaporises in the turbulent carrier gas stream to form the required biocidal gas mixture. The amount of biocidal substance metered into the carrier gas stream is preferably such that the biocidal gas mixture has a temperature at least about 10° C. above its saturation temperature.

Methods

Heated Sparger Process

The liquid biocidal substance may be entrained in the carrier gas by passing the carrier gas through a sparger(s) containing the liquid biocidal substance at a first temperature and is at least maintained at this temperature, which is at or above the saturation temperature or dew point to avoid condensation. A variable quantity of droplets of the liquid biocidal substance may be present and may require the use of an aerosol trap. The biocidal gas mixture is then heated in a second step to a temperature at least 10° C. above dew point prior to its application to the solid material.

Heated Carrier Gas Process

Heating the carrier gas initially to a temperature very substantially above the dew point such that after the biocidal substance(s) has been entrained in the gas, the biocidal gas mixture still has temperature at least 10° C. above the dew point.

Heated Injection Process

The liquid biocidal substance may be entrained in the carrier gas at a first temperature just above the dew point ensuring the injection volatile biocidal substance(s) is not in saturating amounts and is at a desired percentage, that is less than about 100%, of the dew point and then heated in a second step to a temperature at least 10° C. above the dew point prior to its application to the solid material. Alternatively all the heating can be performed in one step.

Preferably, the biocidal substance is entrained in the carrier gas by passing the carrier gas through a sparger(s) containing the liquid biocidal substance or by otherwise injecting the liquid biocidal substance(s) into a flow of carrier gas. Preferably, the entraining or first temperature is in the range of 1 to 200° C. dependent on the type and concentration of the liquid biocidal substance, the desired gaseous concentration, the method of entrainment and the relevant safety issues for the latter parameters. For 75% w/w acetic acid the first temperature is preferably <67° C. for the heated sparger process.

Preferably, the carrier gas is carbon dioxide and/or nitrogen gas. As mentioned above, the volatile biocidal substance(s) is selected from natural food acids, chemical biocidal substances and mixtures thereof. Preferably, the volatile biocidal substance(s) is selected form acetic acid, carbonic acid, hydrogen peroxide and mixtures thereof.

The biocidal substance(s) is, in one embodiment of the invention, preferably initially entrained in the carrier gas in saturating amounts. After contact of the biocidal gas mixture with the solid material, any residual volatile biocidal substance(s) may be stripped from the carrier gas by condensation, compression or other such means and recycled, furthermore the carrier gas, once stripped of the residual volatile biocidal substance(s) could be recycled for use in the process according to the present invention.

The entrained biocidal gas mixture, preferably entrained in saturating amounts, at the first temperature, and is at least maintained at this temperature, which is at the saturation or dew point to avoid condensation. This can be achieved by heating all gas-contact surface areas, under Good Manufacturing Practices (GMP). The energy required to achieve this would be minimised and marginal temperature increase, if any under high flow conditions, would be expected. The second temperature is greater than 10° C. above the dew point temperature, more preferably greater than 80° C. above the dew point temperature. Generally, the temperature at which the biocidal gas is applied to the solid material will be within, the range of 80 to 400° C. If the second temperature is increased to beyond what is required to achieve the desired microbial lethality, the heating of lines downstream may be achieved by the heated gas mixture.

The upper temperature to which a flammable biocidal gas mixture, may be safely heated in the absence of an ignition source and in an atmosphere capable of supporting combustion is set by the auto ignition temperature of the biocidal substance. In the case of glacial acetic acid this is 437° C. The practical limit of “post heating” may be more related to accumulated heat effects on surrounding equipment etc. A cooling and/or condensation point may be required in some applications. The heating of the biocidal gas mixture well above its dew pint achieves improved reductions in the microbial bioburden of solid materials and the additional heat imparted to the materials as a result of the heating of the biocidal gas mixture, as shown in the following non-limiting example, has been found to be minimal and insufficient to cause any substantial degradation or other adverse effects.

The process and apparatus of the present invention does not necessarily require a trap to prevent/remove droplets from contacting the solid material if the biocidal gas mixture is heated to beyond the vaporisation temperature of the volatile biocidal substance. However, the process and apparatus of the present invention preferably utilises at least one aerosol trap to prevent/remove droplets of the volatile biocidal substance in the biocidal gas mixture prior to the heating and contacting steps in order to minimise variances in concentration of the gaseous biocidal substance if the biocidal substance is entrained using the post heat process. It is preferred that the gas-contact surfaces of all conduits (and any sparger(s) and/or aerosol trap(s) and/or accumulator(s) and/or appropriate sections of the treatment equipment) be heated sufficiently to maintain the gas mixture at a temperature at least about 10° C. above the dew point or at a temperature or the desired temperature above the dew point.

Suitable, aerosol traps for use in the present invention may consist of a flexible membrane/bag/bellows to allow for expansion and contraction proportional to the volume of biocidal gas mixture contained within the aerosol trap. This acts as a trap and an accumulator of aerosol/gas and thereby minimises variations in concentration of the volatile biocidal substance in the carrier gas which may otherwise occur as a result variances in the mass of aerosol carriage and/or pressure fluctuation effects on the biocidal gas mixture within a rigid vessel of constant volume. When functioning as a trap it is preferred to use one trap per gaseous biocidal substance, especially if the liquid biocidal substances are somewhat incompatible, (eg. acetic acid and hydrogen peroxide). When functioning solely as an accumulator and/or for mixing various types of gaseous biocidal substances, the flexible vessel may be placed after the heating step and prior to the contact step.

Preferably, the formed biocidal gas mixture is heated using standard heater units (eg passage through a heat transfer device submerged in a bath containing an appropriate heat transfer medium and maintained at the desired temperature) in a manner such that the resulting heated biocidal gas mixture is homogenous at the time of the contacting step with the solid material being treated. That is, the ‘post heater’ will typically consist of a heated surface or surfaces whereupon the biocidal gas mixture comes into contact for a sufficient period of time to at least ensure that the resultant biocidal gas mixture is free from visible droplets of the volatile biocidal substance(s) that will detrimentally effect the material being treated or result in a decrease in process efficacy. More preferably the resultant biocidal gas mixture is free from all droplets of the volatile substance(s) and is heated to the desired second temperature.

The present invention will be further described by way of the following non-limiting examples.

### EXAMPLE 1

### Temperature Rise on a Foodstuff From a Heated Gaseous Biocidal Substance

Cocktail Frankfurts (sausages) were treated with a heated gaseous biocidal substances (see Table 1) and the surface temperature rise was determined using a RAYTECH RY-MID-10LT infrared temperature sensor.

TABLE 1
Treatment of Cocktail Frankfurts

| | |
|---|---|
| Foodstuff | Frankfurts - 25 grams |
| Acetic acid/CO2 gas mix | @ 0.1 g/l |
| First Gas Temperature (° C.) | 36.0 |
| Second Gas Temperature (Additional Heating) | 129.0 |
| (° C.) | |
| Flow rate litres/min. | 25.0 |
| Temperature frankfurt prior treatment (° C.) | 18.1 |
| Treatment time (seconds) | 5.3 |
| Temperature frankfurt immediately post treatment | 22.1 |
| (° C.) | |
| Temperature frankfurt 60 seconds post treatment | 18.3 |
| (° C.) | |

The treatment parameters were similar to Example 2 below, it was therefore expected that the surface temperature rise in the Example 2 would have been similar.

The 4° C. temperature rise in the frankfurts that occurred within 60 seconds can not account for the increase in lethality from >60% to >99.6% in example 2. Therefore, this data supports the partitioning and intimate contact of the heated gaseous biocidal substances.

### EXAMPLE 2

### Treatment of Frankfurt Sausages with Heated Biocidal Gas Mixture

Test treatments of frankfurts with an acetic acid/carbon dioxide biocidal gas mixture were conducted to determine the effect on microbial activity of post-heating.

Methods

Method 1: Standard Treatment

CO₂ gas was passed through approximately 1.5 litres of 90% w/w acetic acid contained in a sparger of approximately 4 litres in volume at the specified flow rate and temperature as set out in Table 2. The gas was then passed through a rigid aerosol trap of approximately 4 litres in volume. The resultant biocidal gas mixture (which comprised acetic and carbonic acid dissolved in the CO₂ gas and presumably invisible small particles of acetic acid suspended in the CO₂ gas) was then directed in to a plastic bag (with an internal volume of approximately 1.6 litres) containing a frankfurt sausage to the specified contact time (see Table 2). During this step, the bag and frankfurt sausage were shaken in order to ensure intimate contact of the biocidal gas mixture with the entire surface of the frankfurt sausage.

Method 2: Modified Treatment with a Post Heated Biocidal Gas Mixture

CO₂ gas was passed through a sparger of approximately 200 litres in volume containing approximately 160 litres of 90% w/w acetic acid at a specified flow rate and temperature as set out in Table 2, and then passed through a rigid aerosol trap of approximately 200 litres in volume. The resultant biocidal gas mixture was then transferred via 10 metres of 65° C. heat traced 25 mm ID line and through a heated coil at 140° C. The heated gas was then transferred by 2 metres of 19 mm ID insulated line to a 3 way valve configuration on the hinged door of a heat traced vacuum chamber (with an internal volume of approximately 9.5 litres) containing approximately three large frankfurt sausages which were placed on a wire rack. The vacuum chamber was directed into the chamber until an overpressure of +20 Kpa/g was achieved, at which point the door was immediately opened and the frankfurt sausages removed. The gas temperature had decreased to 96° C. at the door valving and another decrease to 90° C. was assumed to have occurred in the final transfer through this door valving to the frankfurt sausages.

These comparative treatments were performed using different gas generation and applicator equipment due to the lack of post gas heating equipment of a suitable size to be used in conjunction with the standard treatment method described above. However, the potential error was overcome by ensuring that the 30-second post treatment pH was numerically slightly lower for the standard treatment (see Table 2). Furthermore, as the application of a vacuum had previously been shown to have minimal, if any, effect on treatment of frankfurts, the use of a vacuum in the treatment chamber used in the modified method is believed not to have influenced the results.

Samples

Frankfurts—Large frankfurts were obtained from a retail supermarket. A significant bio-film was present on the surface of the frankfurts, to the extent that a ‘tacky’ film was left on fingers after handling.

Results

The standard treatment resulted in the degradation of the tacky bio-film to about 0.5 mL of a pale brown liquid with the approximate viscosity of water. With the modified treatment, a significant increase on the amount of free/degraded bio-film (i.e. approximately 3 mL) was observed.

Both the standard and modified treatments achieved similar acid transfers as indicated by the surface pH measurements. The overall temperature effect of the modified treatment on the frankfurt sausage temperature appeared to be minimal as a definite ‘chill’ could be felt through the sample bag (see Table 1) after the treatment.

The modified treatment achieved a 99.9% CFU/g reduction as compared with the standard treatment reduction of 98.8%.

TABLE 2
Process, Conditions and Results of Example 2

| | | | | | | | | | % CFU/gm | % CFI/gm |
|---|---|---|---|---|---|---|---|---|---|---|
| | Gas | | | | | | | | reduction | reduction from |
| | Generation | Additional | | | | | 30 sec | | from | standard |
| | Temp | heat above | Final gas | Flow rate | Contact | | post | | common | treatment |
| | (GGT) | (GCT) | temperature | (Liters/ | Time | Vacuum | treatment | TVAC | ‘tacky’ | (process |
| Treatment | (° C.) | (° C.) | (° C.) | min) | (Secs) | (kPag) | surface pH | CFU/gm | control | improvement) |
| Untreated | NA | NA | NA | NA | NA | NA | NA | 2450000 | NA | NA |
| Control | | | | | | | | | | |
| Standard | 19.0 | NL | 19.0 | 25 | 5 | NL | 3.8 to 4.2 | 30500 | 98.75 | NA |
| Modified + Additional | 26.0 | 64 | 90 | 167 | Fixed | −99 | 42 | 2850 | 99.88 | 90.65 |
| Heat | | | *estimated | | volume | | | | | |
| | | | | | number | | | | | |
| TVAC | Total Viable | Count | | | | | | | | |
| CFU/gm | Aerobic | per Gram | | | | | | | | |
| NA | | | | | | | | | | |

Conclusion

Bio-films present a significant breakpoint and inactivator to processes. Therefore, the degradation of the bio-film on the frankfurts treated with the modified treatment to the extent observed whilst still achieving a 3 log reduction in the CFU/g is a substantial achievement and demonstrates the effectiveness of the present invention.

### EXAMPLE 3

### Treatment of Frankfurt Sausages with Heated Biocidal Gas Mixture

Methods

Method 3: Standard Treatment

CO₂ gas was passed through a sparger of approximately 3 litres in volume containing approximately 2.1 litres of >99.5% w/w acetic acid at the flow rate and temperature specified in Table 3, and then passed through a rigid aerosol trap of approximately 3 litres in volume. The biocidal gas mixture was then directed via an air heated line, heated to approximately 50° C., into a plastic bag (with an internal volume of approximately 1.6 litres) containing a frankfurt sausage for a specified contact time (see Table 3). During this step, the plastic bag and frankfurt sausage were shaken in order to ensure intimate contact of the biocidal gas mixture with the entire surface of the frankfurt sausage.

Method 4: Modified Treatment with a Post Heated Biocidal Substance/Gas Mixture.

CO₂ gas was passed through a sparger of approximately 3 litres in volume containing a volume approximately 2.1 litres of >99.5% w/w acetic acid at a specified flow rate and temperature (see Table 3), and then passed through a rigid aerosol trap of approximately 3 litres in volume. The biocidal gas mixture was then directed via an air-heated line, heated to approximately 50° C. into a heated coil of 6.3 mm OD and the biocidal gas mixture heated to 145° C. The heated biocidal gas mixture was then directed into a plastic bag (with an internal volume of approximately 1.6 litres) containing a frankfurt sausage for the specified contact time. During this step, the plastic bag and frankfurt sausage were shaken in order to ensure intimate contact of the biocidal gas mixture with the entire surface of the frankfurt sausage.

Samples

Frankfurts—Cocktail frankfurt sausages were obtained from a retail supermarket and allowed to stand for 14 hours overnight at approximately 18° C. A significant bio-film on the surface of the frankfurts was achieved, to the extent that a ‘tacky’ film was left on fingers after handling of the frankfurt sausages. The frankfurt sausages were re-equilibrated to 4° C. prior to treatment.

Results

The standard and modified treatments used in Example 2, both resulted in the degradation of the ‘tacky’ bio-film to a pale brown liquid with a viscosity approximating that of water. A relative assessment of the volume produced by the two treatments were not conducted.

Both the standard and modified treatments achieved similar acid transfers as indicated by the added total acidity determinations.

The overall temperature rise of the modified treatment on the frankfurt sausage appeared to be minimal as a definite ‘chill’ could be felt through the sample bag after treatment (see Table 3).

The modified treatment achieved a >99.6% TVAC reduction as compared with the standard treatment reduction of >60.0%.

TABLE 3
Process, Conditions and Results of Example 3

| | Gas | Additional | | | | Added | | | | |
|---|---|---|---|---|---|---|---|---|---|---|
| | Generation | heat | Final gas | Flow rate | Contact | titratable | | | | |
| | Temp | above GCT | temperature | (Liters/ | Time | acidity % | | TVAC | % CFU/ | % CFU/ |
| Treatment | (° C.) | (° C.) | (° C.) | min) | (Secs) | w/w | Flavour | gm | gm | gm |
| Untreated | NA | NA | NA | NA | NA | NIL | No acidity | 2450000 | NA | NA |
| | | | | | | | detected | | | |
| Standard | 22.9 | NIL | 22.9 | 25 | 2 | 0.12 | No acidity | 200000 | >60 | NA |
| | | | | | | | detected | | | |
| Modified* | 22.9 | 122.1 | 145 | 25 | 2 | 0.14 | No acidity | 2000 | >99.6 | 99.00 |
| Additional | | | | | | | detected | | | |
| Heat | | | | | | | | | | |

| | |
|---|---|
| TVAC | Total Viable Aerobic Count |
| CFU/gm | Colony Forming Units per |
| NA | Gram |
| | Not applicable |

Conclusion

Degradation of the bio-film on the frankfurt sausages treated with the modified treatment of ‘method 4’ achieved a significant reduction in TVAC of >2 log, which represented a considerable improvements in lethality over the standard treatment. As was seen with the modified treatment in Table 1, and Example 1, the overall temperature effect of the modified treatment on the frankfurt sausage (with post heat treatment) did not increase the surface temperature of the frankfurt sausage substantially. This, at least in part, is why the treated product did not suffer any surface degradation.

Although frankfurt sausages were used in the examples of the present invention, it will be appreciated from the success of the reduction of microbial biofilm that the invention would be suitable for other food products including smallgoods and other solid foods.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-31. (Cancelled)

32. A process for reducing viable microbial content of a solid material for consumption which is susceptible to microbial spoilage and which has an exposed surface having a water activity of greater than or equal to 0.85, the method comprising contacting exposed surfaces of the solid material with a gas mixture comprising a major portion of a carrier gas and a minor portion of a volatile biocide, wherein the carrier gas and/or the gas mixture is heated such that it has a temperature between 30° C. and 300° C. above the dew point of the gas mixture before contacting the exposed surfaces of the solid material.

33. The process according to claim 1 wherein the carrier gas is heated to a temperature of 60° C. to 200° C. above the dew point of the gas mixture.

34. The process according to claim 2 wherein the carrier gas is heated to a temperature of 80° C. to 200° C. above the dew point of the gas mixture.

35. The process according to claims 1 wherein the carrier gas is selected from the group consisting of carbon dioxide, nitrogen, and mixtures thereof.

36. The process according to claim 1 wherein the biocidal substance is selected from the group consisting of natural food acid, volatile chemical biocide, and mixtures thereof.

37. The process according to claim 5 wherein the natural food acid is selected from the group consisting of acetic acid, carbonic acid, and mixtures thereof.

38. The process according to claim 5 wherein the natural food acid is acetic acid.

39. The process according to claim 4 wherein the volatile chemical biocide is hydrogen peroxide.

40. The process according to claim 1 wherein the biocidal substance is entrained in the carrier gas.

41. The process according to claim 9 wherein the solid material is selected from the group consisting of food products, food ingredients, baked goods, bread, whole grain cereals, whole or diced berries, fruits, vegetables, salads, nuts in their shell, stored nut meats, cheese, smallgoods, cured meats, meat, chicken flesh, carcass on abattoir chains, seafood, fresh water foodstuffs, herbs, spices, and mixtures thereof.

42. The process according to claim 10 wherein the solid material is smallgoods or cured meats.

43. The process according to claim 11 wherein the surfaces of the solid material are contacted with the biocidal gas mixture for about 2 minutes or less.

44. The process according to claim 12 wherein the surfaces of the solid material are contacted with the biocidal gas mixture for 10 seconds to 1 minute.
